(19) United States
(12) Patent Application Publication
(10) Pub. No.: US 2019/0216083 A1
(43) Pub. Date: Jul. 18, 2019

(54) ANTI-MICROBIAL COMPOSITIONS, PREPARATIONS, METHODS, AND USES

(71) Applicant: Myco Sciences Limited, Buckinghamshire (GB)

(72) Inventors: Tony John HALL, London (GB); Sarah Jane GURR, Devon (GB)

(73) Assignee: Myco Sciences Limited, Buckinghamshire (GB)

(21) Appl. No.: 16/159,819

(22) Filed: Oct. 15, 2018

Related U.S. Application Data
(63) Continuation of application No. 14/729,138, filed on Jun. 3, 2015, now abandoned.
(60) Provisional application No. 62/007,395, filed on Jun. 3, 2014.

(51) Int. Cl. A01N 37/06; A01N 59/20; A01N 25/02; A01N 59/16

(52) U.S. Cl. CPC A01N 37/06; A01N 59/16; A01N 25/02; A01N 59/20

(57) ABSTRACT

Antimicrobial compositions of phosphorous acid-solubilized copper ammonium complex and phosphorous acid-solubilized copper-zinc ammonium complex combined with a water soluble salt of sorbic acid, such as potassium sorbate, are disclosed. The antimicrobial activity of the compositions are synergistically enhanced with the addition of a water soluble salt of sorbic acid to create a composition that is highly effective against pathogens such as plant pathogenic microorganisms including oomycetes, fungi, and bacteria.

### CROSS-REFERENCE TO RELATED PATENT APPLICATIONS

This application is a continuation of copending U.S. patent application Ser. No. 14/729,138, filed on Jun. 3, 2015, which claims the benefit of U.S. Provisional Patent Application No. 62/007,395, filed Jun. 3, 2014, the disclosures of which are incorporated herein by reference. The above benefit and priority claims are being made in an Application Data Sheet submitted herewith in accordance with 37 C.F.R. 1.76 (b)(5) and 37 C.F.R. 1.78.

### BACKGROUND

### Technical Field

This invention relates generally to compositions with antimicrobial activity, and more specifically to compositions containing phosphorous acid-solubilized copper-ammonium, copper-zinc-ammonium and zinc-ammonium complexes as active ingredients combined with salts of sorbic acid such as potassium sorbate.

### Description of Related Art

The globalization of agriculture has led to crop plants being grown in areas where they may be exposed to new pathogens or new strains of existing pathogens, such as fungi and bacteria, to which they are susceptible. It is estimated that 70% of all major crop diseases are caused by phytopathogenic fungi and it is now acknowledged that plant diseases threaten food supplies.

The development of commercial antifungal agents in agriculture began with copper-based Bordeaux mixture in the 19th century. In the 20th century, many new classes of synthetic organic fungicides with defined modes of action (often single targets) were produced, but the development of fungal resistance to many of these agents has been an increasing problem. In addition, many of these fungicides have toxic effects on the environment, on other species, and can persist in crops and enter the food chain. Consequently, there is a growing need for new fungicides that are safer for the environment and the consumer.

Copper-based fungicides are still extensively used in agriculture today, including organic farming, since they are widely available, inexpensive and relatively safe to use. In addition, fungal resistance to copper-based products is low because copper exerts multiple toxic effects including cell membrane damage and inactivation of iron-sulfur clusters of dehydratase enzymes. However, currently available copper-based products are suspensions of copper compounds, such as copper hydroxide and copper oxychloride, which are used preventatively by sticking to the leaves of plants to prevent fungal development. These copper-based fungicides require frequent application and contain relatively large amounts of copper—Bordeaux mixture contains 2.5 grams/litre of elemental copper—because they provide little ionic copper which is the fungicidal/bactericidal form of copper.

Phosphorous acid in the form of salts such as potassium phosphite is classified as a biopesticide by the US Environmental Protection Agency. Phosphites have both direct and indirect modes of action against oomycetes and fungi. Direct effects include inhibition of mycelia growth and suppression of sporulation and germination. Indirect effects of phosphites include the activation of plant defence responses by mechanisms that are not yet fully elucidated. Phosphites have the advantages of being inexpensive and relatively safe to use, have low toxicity, and by acting via multiple sites of action avoid the development of resistance.

Global health and environmental regulations are increasingly stringent with respect to pesticide residues. Thus, farmers around the world face the dilemma of the need to control destructive pathogens, which requires more fungicide/bactericide use, whilst the regulatory agencies are demanding less chemical residue on crops and in the soil.

Therefore, a need exists for copper-based fungicidal compositions that are at least as potent as existing copper-based products, whilst comprising significantly less copper in the compositions. Ideally, such compositions should have both immediate and extended antifungal effects, as well as having anti-bacterial activity since plant pathogenic bacteria are also a growing problem in agriculture. It is also important that the compositions can be made and used in a safe, cost-effective and environmentally friendly manner. Moreover, there is a growing need for new anti-fungal compositions that have no adverse effects on animal and human health.

### SUMMARY

The present disclosure describes such compositions and the enhanced effects of such compositions when used in combination with salts of sorbic acid.

In one aspect of the present invention, there is provided an antimicrobial composition comprising an acid-solubilized metal-ammonium complex and solubilized aqueous sorbate ion in water, the metal selected from the group consisting of copper, zinc, and a combination of copper and zinc. In certain embodiments, the concentration of elemental copper or elemental zinc in the composition may be between 1 and 10 grams/deciliter, and in certain embodiments, between 3.5 and 5 grams/deciliter. In embodiments where the metal-ammonium complex is zinc-ammonium complex, the ratio of concentration of elemental copper to concentration of elemental zinc may be about 1:1. The solubilized aqueous sorbate ion may be provided by a sorbic acid salt, and in certain embodiments, by potassium sorbate. The acid-solubilized metal-ammonium complex may be phosphorous acid-solubilized metal-ammonium complex.

In another aspect of the present invention, there is provided a method of making an antimicrobial composition. The method comprises dissolving a metal salt in water to form a metal salt aqueous solution, the metal salt selected from the group consisting of copper salt, zinc salt, and mixtures thereof; adding a source of ammonium to the metal salt aqueous solution to form an insoluble metal-ammonium complex; and adding an amount of an acid effective to solubilize the insoluble metal-ammonium complex, thereby forming an aqueous solution of solubilized metal-ammonium complex. The method may be further comprised of adding solubilized aqueous sorbate ion to the aqueous solution of solubilized metal-ammonium complex.

The acid may be selected from the group consisting of phosphoric acid, phosphorous acid, and citric acid. The source of ammonium may be selected from the group consisting of ammonium carbonate, ammonium hydrogen carbonate, and ammonium hydroxide.

The method may be further comprised of diluting the aqueous solution of solubilized metal-ammonium complex with water by a factor of between 100 and 1000. The method may be further comprised of adding at least one adjuvant selected from a carrier, a surfactant, an extender, or a spreader/sticker to the aqueous solution of solubilized metal-ammonium complex.

In another aspect of the present invention, there is provided a method of inhibiting infection of a plant by a microbe. The method comprises applying to the plant an effective amount of an anti-microbial composition comprising an acid-solubilized metal-ammonium complex and solubilized aqueous sorbate ion in water, the metal selected from the group consisting of copper, zinc, and a combination of copper and zinc. The microbe may be a fungus or a bacterium.

In another aspect of the present invention, there is provided a method of inhibiting the growth of T. rubrum in a human. T. rubrum is the human pathogenic fungus responsible for athlete's foot, “jock itch” and ringworm. The method comprises applying to an area of the human that is afflicted with T. rubrum an effective amount of a composition comprising an acid-solubilized metal-ammonium complex and solubilized aqueous sorbate ion in water, the metal selected from the group consisting of copper, zinc, and a combination of copper and zinc.

The foregoing SUMMARY has been provided by way of introduction, and is not intended to limit the scope of the invention as described in this specification and the attached drawings.

### BRIEF DESCRIPTION OF THE DRAWINGS

The present disclosure will be provided with reference to the following drawings, in which like numerals refer to like elements, and in which:

FIG. 1 is a is a graph depicting the effects of compositions and compounds on the growth of Fusarium graminearum;

FIG. 2 is a graph depicting the effect of potassium sorbate on the growth of five plant pathogenic fungi;

FIG. 3 is a is a graph depicting the effect of potassium sorbate on the growth of Magnaporthe oryzae in the presence and absence of composition Cu—Zn#12 (0.15% of stock solution);

FIG. 4 is a graph depicting the inhibition of Magnaporthe oryzae spore germination by Cu—Zn#Z12;

FIG. 5 is a graph depicting the lack of phytotoxicity of Cu—Zn#12 to rice plants;

FIG. 6 is a graph depicting defense signaling by Cu—Zn#12-treated rice plants in response to infection with Magnaporthe oryzae;

FIGS. 7A and 7B are photographs depicting Magnaporthe oryzae infection on rice leaves treated, respectively, with water as a control, and with Cu—Zn#12;

FIG. 8 is a graph depicting the effects of selected compositions and compounds on the growth of Trichophyton rubrum; and

FIG. 9 is a graph depicting the effect of potassium sorbate on the growth of Trichophyton rubrum in the presence and absence of compositions Cu#28 and Cu—Zn#12 (0.1% of stock solution).

The present invention will be described in connection with certain preferred embodiments. However, it is to be understood that there is no intent to limit the invention to the embodiments described. On the contrary, the intent is to cover all alternatives, modifications, and equivalents as may be included within the spirit and scope of the invention as defined by the appended claims.

### DETAILED DESCRIPTION

The present invention and the various embodiments described and envisioned herein include compositions, preparations, methods and uses for the heretofore unknown synergistic anti-microbial activity of phosphorous acid-solubilized copper-ammonium complexes, copper-zinc-ammonium complexes and zinc-ammonium complexes with salts of sorbic acid such as potassium sorbate. The present invention will be described by way of example, and not limitation. Modifications, improvements and additions to the invention described herein may be determined after reading this specification and viewing the accompanying drawings; such modifications, improvements, and additions being considered included in the spirit and broad scope of the present invention and its various embodiments described or envisioned herein.

The anti-fungal activity of the composition disclosed herein has been proven to be greater than with copper and/or zinc salt and/or phosphorous acid alone, indicating an unexpectedly enhanced direct anti-fungal growth effect of these compositions against a wide range of economically important plant pathogenic fungi, four economically important plant pathogenic bacteria, and also the human pathogenic fungus Trichophyton rubrum (T. rubrum), which causes athlete's foot. Surprisingly, the direct anti-fungal growth effect of these compositions is enhanced synergistically by the widely used, inexpensive and generally-regarded as safe (GRAS) food preservative, potassium sorbate, at concentrations used at or below those used in foodstuffs. Taken together, the novel combination, preparation, methods and uses for copper- and/or zinc-based compositions in combination with salts of sorbic acid such as potassium sorbate provides antimicrobial compositions such agricultural fungicides and/or bactericides containing considerably lower levels of copper and/or zinc than currently available copper/zinc products. Since the compositions contain phosphorous acid which is known to stimulate a plant's defenses against fungal and bacterial pathogens, the Applicants hypothesize that the activity of the compositions against fungi and bacteria in planta should be even more impressive than just the direct anti-fungal and anti-bacterial effects described herein.

In one aspect of the present invention, surprisingly efficacious inhibition of fungal growth by phosphorous acid-solubilized copper-ammonium (Cu#), copper-zinc-ammonium (Cu—Zn#) and zinc-ammonium (Zn#) complexes has been observed, as compared to the effect of copper and/or zinc salts alone or phosphorous acid alone. (As used herein, the “#” symbol is meant to indicate the complexing of ammonium ions with the chemical species that precedes it.) Furthermore, the unexpected synergistic inhibition of fungal growth has been observed when such compositions are used in conjunction with sorbic acid in the form of a water-soluble salt such as potassium sorbate, and at potassium sorbate concentrations recommended for use in food and cosmetics (≤0.1% wt/wt or wt/vol). These compositions alone, and particularly in combination with potassium sorbate, represent potentially more attractive fungicides than currently used copper-based fungicides which are suspensions of copper salts that need to be used in high concentrations because the levels of ionic, active copper are very low. The present compositions are solutions of ionic copper (or copper-zinc), and consequently they inhibit the growth of plant pathogenic fungi at concentrations of copper significantly lower than those found in current fungicides such as Bordeaux mixture, copper hydroxide etc. Consequently, since copper at high concentrations is an environmental toxin, it is expected that the present compositions, either alone or in combination with potassium sorbate, should be more environmentally friendly than current copper-based products.

It has been shown that the phytotoxicity of copper to, for example, rice seedlings, is ameliorated in the presence of zinc (Thounaojam T. C. et al. Protoplasma 251:61-69, 2014). The most effective anti-fungal Cu—Zn# composition described herein (Cu—Zn#12) is shown to have anti-fungal activity similar to equivalent Cu# only compositions (e.g. Cu#28), but since Cu—Zn#12 contains only 50% of the copper of Cu#28 with an equimolar amount of zinc, it should be more environmentally and plant friendly. Cu—Zn#12 is shown to have potent anti-fungal activity alone and in synergy with potassium sorbate against a wide range of agriculturally important plant pathogenic fungi (see TABLE 2), including Magnaporthe oryzae (rice blast) and Botrytis cinerea (gray mold), which are considered to be the two most scientifically and economically important plant-pathogenic fungi (Dean R. et al. Molecular Plant Pathology 13:414-430, 2012).

The Cu# and Cu—Zn# (but not Zn#) compositions described herein are also shown to have significant anti-bacterial activity against four of the top five scientifically and economically important plant pathogenic bacteria (Mansfield, J., et al. Molecular Plant Pathology 13:614-629, 2012), at concentrations similar to those that are effective at inhibiting the growth of plant pathogenic fungi. Finally, the Cu#, Cu—Zn# and Zn# compositions described herein are also shown to be potent inhibitors of the growth of T. rubrum, the human pathogenic fungus responsible for athlete's foot, “jock itch” and ringworm. These compositions also show synergistic enhancement of anti-fungal activity against T. rubrum when combined with potassium sorbate and they may therefore have therapeutic applications in the treatment of T. rubrum-associated infections either alone or in combination with potassium sorbate.

The phosphorous acid-solubilized copper-ammonium, copper-zinc-ammonium and zinc-ammonium compositions are conveniently prepared according to the general procedure outlined below. These disclosed embodiments of the present invention exemplify certain preferred compositions; however, these examples are not intended to limit the scope of the present invention. As will be apparent to those skilled in the art, multiple variations and modifications may be made without departing from the spirit and broad scope of the present invention.

The anti-microbial composition of the present invention comprises a phosphorous acid-solubilized copper-ammonium complex, a phosphorous acid solubilized copper-zinc-ammonium complex, or a phosphorous acid solubilized zinc-ammonium complex, in water, and sorbic acid or a salt thereof.

In some embodiments, the antimicrobial composition includes a solution comprising a copper salt or a copper salt and a zinc salt in water; a basic ammonium salt added to the copper salt or copper salt and zinc salt solution to generate an insoluble copper-ammonium complex or copper-zinc-ammonium complex; and phosphorous acid added to the solution to solubilize the copper-ammonium complex or copper-zinc-ammonium complex and to control the pH of the clear blue acid-solubilized copper-ammonium or copper-zinc-ammonium solution thus formed.

In some embodiments, the sorbic acid salt is sodium sorbate or potassium sorbate. In some embodiments, the copper salt may be copper sulfate or copper chloride. In some embodiments, the zinc salt may be zinc sulfate or zinc chloride. In some embodiments of the present invention, the basic ammonium salt may be ammonium hydroxide, ammonium carbonate, or ammonium hydrogen carbonate.

In some embodiments, the water may be distilled water, deionized water, purified water, filtered water, pharmaceutical grade water, medical grade water, and reverse osmosis water. In some embodiments, the copper and/or zinc salt used to make the solution is anhydrous. In some embodiments, the copper and/or zinc salt used to make the solution is hydrated. In some embodiments, the ratio of copper to zinc in the composition is in the range of 10:1 to 1:10, more preferably 3:1 to 1:3, and even more preferably 1:1. In some embodiments, the composition further comprises auxiliaries, adjuvants, carriers, surfactants or extenders.

The following example describes the general protocol for making a stock solution of the phosphorous acid-solubilized copper-zinc-ammonium complex composition called Cu—Zn#12. All chemicals were obtained from Sigma-Aldrich Company Ltd., The Old Brickyard, New Road, Gillingham, Dorset SP8 4XT, UK, unless otherwise stated.

8.0 grams of copper sulfate pentahydrate was added to 80 milliliters of distilled water in a glass beaker using a magnetic stirrer and a stir bar with vigorous mixing to form a clear blue solution. 8.8 grams of zinc sulfate heptahydrate was added to the copper sulfate solution and stirred until dissolved. 4.0 milliliters of ammonium hydroxide (10% solution) was added to the copper sulfate/zinc sulfate drop-wise. A pale blue copper-zinc-ammonium complex particulate suspension was formed during the addition of the ammonium hydroxide solution to the copper sulfate/zinc sulfate solution. The copper-zinc-ammonium complex was kept in suspension with vigorous stirring. 4.0 grams of phosphorous acid was then gradually added in approximately 0.5 gram aliquots to solubilize the copper-zinc-ammonium complex. Sufficient acid must be added so as to completely solubilize the copper-zinc-ammonium complex and to control the pH of the solution. The resulting clear blue solution was vigorously stirred for a further 5 minutes and then made up to a final volume of 100 milliliters with distilled water.

It is preferred that the elemental concentration of copper and zinc in the Cu—Zn# compositions is of the order 1:1 with the solvent phase being distilled or deionised water. In certain embodiments, the ratio of elemental concentration of copper to elemental concentration of zinc in the Cu—Zn# compositions may be between 1:10 and 10:1.

For Cu# and Zn# compositions, it is preferred that the concentration of elemental copper or zinc in the compositions is of the order 1 to 10 grams/deciliter preferably 3 to 7 grams/deciliter, more preferably 3.5 to 5 grams/deciliter, with the solvent phase being distilled or deionised water.

For examples of other phosphorous acid-solubilized Cu#, Cu—Zn# and Zn# compositions based on this protocol see TABLE 1 below. In the TABLE, gram or grams is abbreviated with the letter g and milliliter or milliliters are abbreviated with the letters ml.

TABLE 1
Examples of phosphorous acid-solubilized Cu#, Cu—Zn# and Zn# compositions.

| | Ingredients added per deciliter of distilled water | | | | | | |
|---|---|---|---|---|---|---|---|
| | | | | | Basic ammonium | | |
| Composition | CuSO₄•5H₂0 | | ZnSO₄•7H₂0 | | salt | | Acid |
| Cu#28* | 16.0** | | — | | 4.0 | ml NH₄OH**** | 4.0 g H₃PO₃ (85%) |
| Cu—Zn#12* | 8.0 | g*** | 8.8 | g*** | 4.0 | ml NH₄OH | 4.0 g H₃PO₃ (85%) |
| Cu—Zn#13 | 8.0 | g | 0.88 | g | 4.0 | ml NH₄OH | 4.0 g H₃PO₃ (85%) |
| Cu—Zn#14 | 8.0 | g | 2.93 | g | 4.0 | ml NH₄OH | 4.0 g H₃PO₃ (85%) |
| Cu—Zn#15 | 2.66 | g | 8.8 | g | 4.0 | ml NH₄OH | 4.0 g H₃PO₃ (85%) |
| Cu—Zn#16 | 0.8 | g | 8.8 | g | 4.0 | ml NH₄OH | 4.0 g H₃PO₃ (85%) |

| | | | | | | |
|---|---|---|---|---|---|---|
| Zn#4* | — | 17.6 | g** | 4.0 | ml NH₄OH | 4.0 g H₃PO₃ (85%) |

*The indicated compositions differ only in the amounts of Cu and/or Zn present so that they could be used for comparative purposes in the experiments presented herein.
**The indicated amount produces a stock solution of approximately 4.0 grams/deciliter of elemental copper or zinc.
***The indicated amounts produce a stock solution of approximately 2.0 grams/deciliter of both elemental copper and elemental zinc.
****NH₄OH 10% solution.

Stock solutions of copper sulfate (16 grams/deciliter), zinc sulfate (17.6 grams per deciliter), and phosphorous acid (4 grams/decilitre) were used as controls for the compositions in experiments. Potassium phosphite was prepared by reacting 2.8 grams of potassium hydroxide with 4 grams of phosphorous acid in 100 milliliters of distilled water as described above.

Potassium sorbate (KS) is highly soluble in water (58.2% at 20° C.) and is typically used at concentrations up to 0.1% (1000 milligrams/liter) in food and cosmetic products. KS can be dissolved in distilled or deionized water to form a stock solution, e.g. 10 grams/liter in distilled water.

It is envisaged that for practical use in agriculture etc., the stock solution of a Cu#, Cu—Zn# or Zn# composition would be added to water with mixing or stirring to a dilution of, for example, 100- to 1,000-fold. An appropriate amount of a stock solution of KS, e.g. 10 grams/liter would then be added with continued stirring or mixing to a dilution of, for example, 100- to 1,000-fold. An appropriate adjuvant, such as a carrier, surfactant, extender, or spreader/sticker may then be added at an appropriate concentration to the effective amount of the combined product. (As used herein, the term “adjuvant” is meant to indicate an additional substance that enhances the effect of the antimicrobial compositions when they are in use.) Such adjuvant(s) operate in a beneficial manner to cause enhanced absorption of the composition by a plant being treated therewith, improved wetting and spreading of the composition on the leaves and stems of the plant being treated therewith, and/or improved adhesion of the composition on the leaves and stems of the plant being treated therewith.

In order that the present invention may be illustrated, more easily appreciated and readily carried into effect by those skilled in the art, embodiments thereof will now be presented by way of non-limiting examples only and described with reference to the accompanying drawings.

### EXAMPLE 1

### Fungal Growth Inhibition Assays with Eight Plant Pathogenic Fungal Strains

The compositions Cu#28, Cu—Zn#12 and Zn#4, and the compounds copper sulfate, zinc sulfate, potassium phosphite and phosphorous acid are shown in TABLE 1 and/or described in the legend of TABLE 1 and the associated text.

The fungal strains used in these studies are described in TABLE 2. The strains were routinely cultured in 9 centimeter Petri dishes containing 10 milliliters of potato dextrose agar (PDA) at room temperature (22° C.) apart from U. maydis (28° C.).

To assess the effects of compositions on fungal growth, 10 microliters of the test compositions diluted in sterile distilled water were placed in the wells of a 12-well tissue culture plate and 1 milliliter of liquid PDA was added by pipette to each well. Where multiple samples were added to each well, the 10 microliter drops were kept separate until they were mixed by the addition of hot liquid PDA and the plate was then agitated to evenly distribute the test composition(s) evenly through the agar (distilled water was used as vehicle control) and then the agar was allowed to set. For most strains (see TABLE 2), plugs of agar containing fungal hyphae (2 to 3 millimeters in diameter) from the edge of an established fungal culture were carefully cut out using a scalpel and inserted into holes cut in the centre of the agar in each well of the 12-well plate. With B. cinerea and U. maydis, mature cultures were washed with 3 ml of sterile distilled water and the spore suspensions obtained were adjusted to O.D. (at 600 nanometers) of 1.0 and 1.5, respectively. A small hole (˜1 millimeter) was made in the center of the PDA in each well with a yellow pipette tip and 1.5 microliters of spore suspension was carefully pipetted into the hole. The plates were then cultured at the temperatures noted above and for the number of days shown in TABLE 2. In some experiments, 10% PDA (with 90% agar) was used as described above, except that the culture period was usually increased (see TABLE 5). To assess the effects of compositions on fungal growth in all experiments, the diameter of the hyphal growth was measured twice at a 90° angle using a ruler and the average diameter in millimeters was calculated. If no fungal growth could be detected by eye, the cultures were observed by phase microscopy (40×) to confirm that there was no growth (NG).

TABLE 2
Fungal strains used.

| | | Form used; |
|---|---|---|
| Fungal strain | Disease caused by fungus | Culture period |
| Alternaria | Early blight of potato | Agar plugs; |
| alternata (Asc)* | and infects many other | 2 days |
| | plants. Can cause respiratory | |
| | tract infections in man. | |
| Aspergillus | Black mold of onions, | Agar plugs; |
| niger (Asc) | grapes and peanuts. | 6 days |
| Botrytis cinerea | Gray mold. Infects more | Spore |
| (Asc) | than 200 species. Also a | suspension; |
| | problem post-harvest. | 2 days |
| Fusarium | Causes head blight in | Agar plugs; |
| graminearum | wheat, barley etc. | 3 days |
| (Asc) | Reduces grain quality. | |
| Magnaporthe | Rice blast. Can cause losses of | Agar plugs; |
| oryzae (Asc) | 10-30% of grain yield in the | 4 days |
| | world's biggest food source. | |
| Mycosphaerella | Septoria blotch disease of wheat. | Agar plugs; |
| graminicola | | 8 days |
| (Asc) | | |
| Rhizoctonia | Rice sheath blight. Affects | Agar plugs; |
| solani (Bas)* | other crop species. | 1 day |
| Ustilago maydis | Corn smut. | Spore |
| (Bas) | | suspension; |
| | | 5 days |

*Phylum: Asc = Ascomycota;
Bas = Basidiomycota.

### Results.

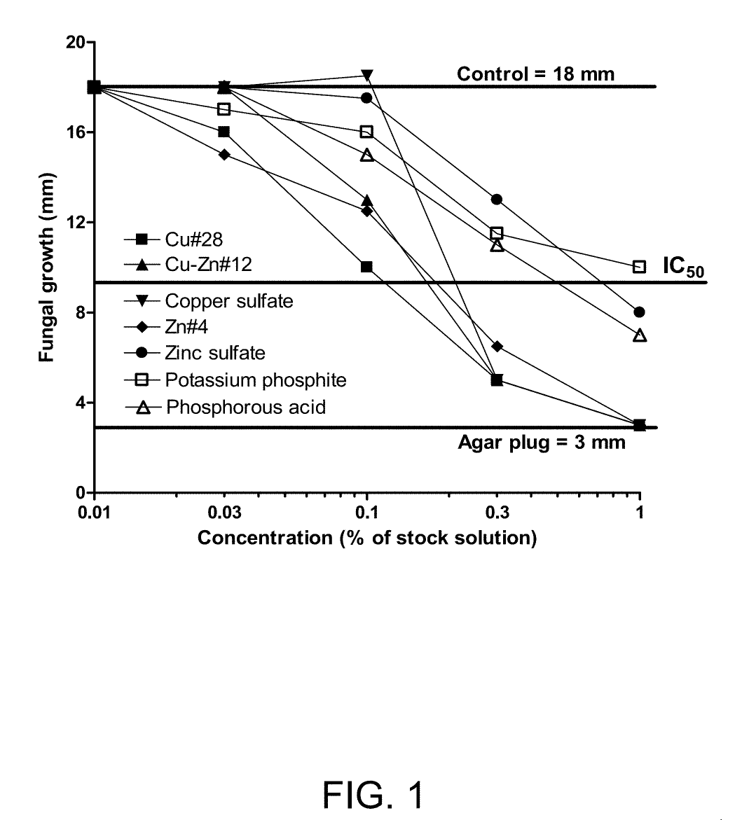

FIG. 1 is a graph depicting the effects of compositions and compounds on the growth of Fusarium graminearum. The culture period was 3 days. Growth in the control cultures was 18±0 millimeters (mean±SD for 3 experiments). The 50% inhibitory concentration (IC₅₀) for compositions was that at which hyphal growth was 9.0 millimeters.

FIG. 1 shows the dose response curves for various compositions and compounds on the hyphal growth of F. graminearum (on PDA, 3 day cultures) and indicates how the 50% inhibitory concentration (IC₅₀) for compositions was determined from such graphs.

In the case of F. graminearum, the copper based compositions Cu#28, Cu—Zn#12 and copper sulfate were strong inhibitors of fungal growth with IC₅₀ values of 0.096, 0.16 and 0.22% (see TABLE 3) of stock solutions (see TABLE 1), respectively. The stock solution of Cu#28 and copper sulfate contain 40 grams/liter of elemental copper, so that their IC₅₀ values of 0.096% and 0.22% represent a copper concentration of 38 and 88 milligrams/liter, respectively, indicating that Cu#28 is more than twice as effective an inhibitor of fungal growth than copper sulfate. Composition Cu—Zn#12 contains 20 grams/liter of elemental copper and zinc, so the IC₅₀ of 0.16 represents copper and zinc concentrations of 32 milligrams/liter each. Since zinc sulfate (IC₅₀=0.66%) is considerably less active than copper sulfate (IC₅₀=0.22), this suggests that the activity of Cu—Zn#12 is mainly due to copper. However, it is interesting to note that Zn#4 (IC₅₀=0.17%), which contains zinc sulfate (IC₅₀=0.66%) and phosphorous acid (IC₅₀=0.78%), is as active Cu—Zn#12 and considerably more active than might be expected from its constituents indicating a surprising synergistic effect. Since zinc salts have fewer of the environmental toxicity issues associated with copper salts, Zn#4 and Cu—Zn#12 may be advantageous anti-fungal agents in the field compared to Cu#28. Cu#28, Cu—Zn#12 and Zn#4 were all more effective (4-, 2.5-, and 2.3-times, respectively) than potassium phosphite, a widely used anti-fungal agrochemical, despite the fact that they all contain the same amount of phosphorous acid, again indicating that the combination of copper and/or zinc with phosphorous acid results in a surprising synergistic effect resulting in more potent anti-fungal compositions than might be expected.

Graphs similar to that shown in FIG. 1 were plotted for the compositions and compounds tested on all of the fungal strains shown in TABLE 2 and from those graphs (not shown) IC₅₀ values were determined.

TABLE 3 shows that Cu#28 and Cu—Zn#12 had similar IC₅₀ values with most fungal strains and were the most active compositions in the majority of cases. In general, Cu#28 and Cu—Zn#12 were 2- to 3-fold more active than copper sulfate; Zn#4 was usually the next most active composition on most fungal strains and was also around 2- to 3-fold more active than zinc sulfate.

Taking the results with M. oryzae as an example, it is clear that the IC₅₀ value of composition Cu#28 (0.18%) is surprisingly low considering the IC₅₀ values of its components copper sulfate (0.51%) and phosphorous acid (0.57%). Similarly, the IC₅₀ of Zn#4 (0.27%) is unexpected from those of zinc sulfate (0.48%) and phosphorous acid (0.57%). Since similar results were seen with six of the other plant pathogenic fungi tested (not A. niger) and since potassium phosphite had IC₅₀ values 2 to 5-fold higher than the Cu#, Cu—Zn# or Zn# compositions (except M. oryzae, 13.7-fold higher), these results taken together indicate a surprisingly enhanced anti-fungal activity in the Cu#, Cu—Zn# and Zn# containing phosphorous acid-solubilized compositions.

Phosphorous acid and potassium phosphite were generally the least active inhibitors of fungal growth, with the exception of A. niger which was particularly sensitive to these two compositions. As with M. oryzae, the growth of most fungal strains was surprisingly inhibited very effectively by Cu—Zn#12 which contains only 50% of the copper concentration of Cu#28. As mentioned above in the detailed discussion on F. graminearum, this has implications for the potential use of Cu—Zn-based compositions in the field where the nutritional value of zinc coupled with its lower toxicity in the environment compared to copper could be highly beneficial, especially when combined with highly effective direct inhibition of the growth of plant pathogenic fungi. Furthermore, it has been shown that the phytotoxic effect of copper on rice seedlings in a hydroponic system can be ameliorated by the presence of zinc (Thounaojam T. C. et al. Protoplasma 251:61-69, 2014), suggesting that the Cu—Zn# compositions may have numerous advantages over Cu# compositions in the field.

TABLE 3
Concentrations of compositions and compounds that inhibited fungal growth by 50%* (IC₅₀) for 8 plant pathogenic fungi.

| | *IC₅₀ values: % of composition stock solution/Concentration of copper or zinc in the composition, or | | | | | | | |
|---|---|---|---|---|---|---|---|---|
| | phosphorous acid (mg/L) | | | | | | | |
| Composition | M. oryzae | F. graminearum | B. cinerea | R. solani | A. alternata | U. maydis | A. niger | M. graminicola |
| Cu#28 | 0.18/72 | 0.096/38 | 0.19/76 | 0.18/72 | 0.17/68 | 0.14/56 | 0.12/48 | 0.065/26 |
| Cu—Zn#12** | 0.20/80 | 0.16/64 | 0.20/80 | 0.18/72 | 0.15/60 | 0.22/88 | 0.13/52 | 0.12/48 |
| Copper sulfate | 0.51/204 | 0.22/88 | 0.46/184 | 0.39/156 | 0.44/176 | 0.43/172 | 0.19/76 | ND |
| Zn#4 | 0.27/108 | 0.17/68 | 0.27/108 | 0.17/68 | 0.30/120 | 0.27/108 | 0.15/60 | 0.27/108 |
| Zinc sulfate | 0.48/192 | 0.66/264 | 0.52/208 | 0.33/132 | 0.62/248 | 0.56/224 | 0.25/100 | ND |
| Phosphorous | 0.57/228 | 0.39/156 | 0.63/252 | 0.64/256 | 0.51/204 | 0.75/300 | 0.19/76 | ND |
| acid | | | | | | | | |
| Potassium | 3.7 | 0.78 | 0.67 | 0.93 | 1.1 | 1.3 | 0.19 | ND |
| phosphite (%) | | | | | | | | |

The concentration of each composition in mg/L is also shown;
**except in the case of Cu—Zn#12 where the concentration in mg/L is 50% each of elemental copper and zinc; so, for example, the IC₅₀ value of 80 mg/L for Cu—Zn#12 on M. oryzae represents 40 mg/L each for copper and zinc.
ND = not determined.

TABLE 4
Experimental reproducibility.

| | Concentration (% of composition stock solution) that | | | | | |
|---|---|---|---|---|---|---|
| | inhibited fungal growth by 50% (IC₅₀) | | | | | |
| | Cu#28 | | Cu—Zn#12 | | Zn#4 | |
| Composition | IC₅₀ | Mean ± SD | IC₅₀ | Mean ± SD | IC₅₀ | Mean ± SD |
| A. alternata | 0.17 | 0.16 ± 0.02 | 0.15 | 0.16 ± 0.01 | 0.30 | 0.26 ± 0.05 |
| | 0.14 | | 0.16 | | 0.22 | |
| B. cinerea | 0.19 | 0.21 ± 0.03 | 0.20 | 0.20 ± 0 | 0.27 | 0.29 ± 0.02 |
| | 0.23 | | 0.20 | | 0.30 | |
| F. graminearum | 0.096 | 0.098 ± 0.003 | 0.16 | 0.14 ± 0.04 | 0.15 | 0.14 ± 0.02 |
| | 0.10 | | 0.11 | | 0.12 | |
| M. oryzae | 0.18 | 0.18 ± 0.01 | 0.20 | 0.20 ± 0.02 | 0.27 | 0.27 ± 0.01 |
| | 0.18 | | 0.19 | | 0.26 | |
| | 0.19 | | 0.22 | | 0.27 | |
| R. solani | 0.18 | 0.18 ± 0.01 | 0.18 | 0.17 ± 0.01 | 0.17 | 0.16 ± 0.01 |
| | 0.18 | | 0.16 | | 0.17 | |
| | 0.17 | | 0.16 | | 0.15 | |

The IC₅₀ values from 2 or 3 separate experiments were used to calculate mean ± standard deviation (SD) values for the effects of Cu#28, Cu—Zn#12 and Zn#4 tested on 5 fungal strains.

Owing to the labor-intensive nature of the fungal assays, experiments were sometimes run only once. When replicate IC₅₀ values were obtained, such as those shown in TABLE 3, the results were analysed to assess inter-experimental reproducibility.

The results in TABLE 4 show that the replicate results were within an experimental error of 10% or less in 10 of 15 cases. Overall, the average experimental error for the 3 compositions tested was: Cu#28=8%, Cu—Zn#12=10%, Zn#4=10%. These results indicate that experimental error in this fungal culture system can be considered to be around 10%.

TABLE 5
Comparison of IC₅₀ values of 3 compositions tested against
5 fungal strains on normal PDA or 10% PDA.

| | IC₅₀ values in mg/L* | | | | | |
|---|---|---|---|---|---|---|
| | | | | | Zn#4 | |
| | Cu#28 | | Cu—Zn#12** | | | 10% |
| Composition | PDA | 10% PDA | PDA | 10% PDA | PDA | PDA |
| A. alternata | 64 | 1.5 | 64 | 1.8 | 104 | 7.6 |
| B. cinerea | 84 | 5.2 | 80 | 5.6 | 116 | 6.8 |
| F. graminearum | 40 | 3.1 | 52 | 3.7 | 56 | 4.0 |
| M. oryzae | 72 | 2.4 | 80 | 2.0 | 104 | 3.9 |
| R. solani | 72 | 5.2 | 68 | 6.0 | 64 | 6.8 |
| Average | 66 | 3.8 | 69 | 3.8 | 89 | 5.8 |
| (% of PDA) | | (5.8%) | | (5.5%) | | (6.5%) |

*The IC₅₀ values are shown in milligrams/liter of elemental copper or zinc,
**except in the case of Cu—Zn#12 where the concentration in mg/L shown is 50% each of elemental copper and zinc.
Thus, for example, the IC₅₀ value of 68 mg/L for Cu—Zn#12 with R. solani on PDA represents 34 mg/L each for copper and zinc.
The culture periods on 10% PDA were 3, 5 and 12 days for B. cinerea, M. oryzae and F. graminearum, respectively (compared to 2, 4 and 3 days, respectively, on PDA).
The culture periods for R. solani and A. alternata on 10% PDA were 1 and 2 days, respectively, as for PDA.
The average IC₅₀ values (%) for the 5 fungal strains grown on PDA were taken from TABLE 4 and converted to milligrams/liter by multiplying by 400.

PDA is a highly nutritious culture medium designed for optimal fungal growth. The conditions in nature for fungi attempting to grow on plants could be considered to be rather more exacting, so in some experiments fungi were grown on 10% PDA (90% agar, 10% PDA). The results in TABLE 5 show that the growth of all five fungal strains grown on 10% PDA was considerably more sensitive to the 3 compositions tested than when the five fungal strains were grown on normal PDA, as demonstrated by comparing the average IC₅₀ values on 10% PDA to the average IC₅₀ values as shown in TABLE 4 (converted from % of stock solutions to milligrams/liter of elemental copper or zinc).

The IC₅₀ values with 10% PDA are around 16-times lower (5.5-6.5%) on average than those on normal PDA indicating that under less optimal culture conditions the growth of these five fungal strains is more sensitive to the compositions. No growth was observed on 10% PDA with a 0.1% dilution of Cu#28 (40 milligrams/liter elemental copper) and Cu—Zn#12 stock solutions (20 milligrams/liter each of elemental copper and zinc) with all five fungal strains tested. If such low concentrations of phosphorous acid-solubilized copper/copper-zinc compositions were found to be effective at inhibiting fungal growth on plants, these compositions would represent more environmentally friendly fungicides than other copper-based products such as Bordeaux mixture which contains 2,500 milligrams/liter of elemental copper.

The composition Cu—Zn#12 contains equimolar concentrations of elemental copper and zinc (20 grams/liter each in the stock solution—see TABLE 1), so it was of interest to assess the effectiveness of compositions with differing ratios of copper and zinc to inhibit fungal growth.

Thus, compositions Cu—Zn#13-16 (see TABLE 1), were tested for their ability to inhibit the growth of Rhizoctonia solani and compared to Cu#28, Cu—Zn#12 and Zn#4 as shown in TABLE 6. In all stock compositions the total concentration of elemental copper and/or zinc was 40 grams/liter, whilst the amounts of ammonium hydroxide and phosphorous acid used were the same in all five compositions (see TABLE 1).

The results in TABLE 6 show that Cu—Zn#12 (Cu:Zn-1:1; IC₅₀=0.18%) was the most active of the five Cu—Zn# compositions tested, followed by Cu—Zn#14 (Cu:Zn=3:1; IC₅₀=0.23%). Although the five compositions anti-fungal activity was quite similar, Cu—Zn#12 which has equimolar elemental copper and zinc concentrations was clearly the most effective composition. The results in TABLE 6 also show that inhibition of the growth of R. solani is equally sensitive to copper- or zinc-based compositions in the form of Cu#28 or Zn#4, with IC₅₀ values of 0.18% and 0.17% respectively, so the equivalent IC₅₀ of Cu—Zn#12 was not unexpected in this case based upon the overall results of our experiments.

These results show that an elemental copper:zinc ratio of 1:1 is optimal for inhibition of fungal growth, but notably all of the compositions (except Cu—Zn#13) completely inhibited the growth of R. solani at a 1% dilution of stock solution.

TABLE 6
The effect of compositions containing varying ratios of copper and
zinc on the growth of Rhizoctonia solani on PDA.

| | | | Concentration | | | |
|---|---|---|---|---|---|---|
| | | | (% of stock solution) | | | |
| | | | 1 | 0.3 | 0.1 | 0.03 |
| | | | Diameter of | | | |
| Composition | Cu:Zn | *IC₅₀ (%/mg/L) | fungal growth (mm) | | | |
| Cu—Zn#12 | 1:1 | 0.18/72 | NG | 4 | 15 | 18 |
| Cu—Zn#13 | 10:1 | 0.30/120 | 3 | 10.5 | 15 | 18 |
| Cu—Zn#14 | 3:1 | 0.23/92 | NG | 8 | 15 | 18 |
| Cu—Zn#15 | 1:3 | 0.30/120 | NG | 10.5 | 17 | 18 |
| Cu—Zn#16 | 1:10 | 0.34/136 | NG | 11 | 17 | 18 |
| Cu#28 | 1:0 | 0.18/72 | NG | 4 | 15 | — |
| Zn#4 | 0:1 | 0.17/68 | NG | NG | 15 | — |

Fungal growth in the controls was 18 ± 0 millimeters (mean ± SD, 4 experiments).
*IC₅₀ values are shown as percent of stock solutions and in milligrams/liter of elemental copper (Cu#28) or zinc (Zn#4), except in the case of all Cu—Zn# compositions where the concentration in mg/L is 50% each of elemental copper and zinc.
NG = no growth.

### EXAMPLE 2

### Fungal Growth Inhibition Assays with Eight Plant Pathogenic Fungal Strains: Synergy of Compositions with Potassium Sorbate (KS)

There is an ever-increasing demand for new fungicides in agriculture that are not toxic to plants, safe to use, safe for the environment and that do not persist in the grain, fruit, vegetable etc., when harvested. The compositions Cu#28 and Cu—Zn#12 completely inhibit the growth of all eight plant pathogenic fungi tested at a 1% dilution of stock solution (TABLE 1), which is equivalent to 400 milligrams/liter of elemental copper for Cu#28 and 200 milligram/liter each of elemental copper and zinc for Cu—Zn#12. The concentration of elemental copper in Bordeaux mixture is 2,500 milligrams/liter which is 6-times and 12-times higher respectively than the concentration of elemental copper in 1% dilutions of stock solutions of Cu#28 and Cu—Zn#12.

Ideally, agrochemicals should be easy and safe to use, as well as being inexpensive and effective. The compositions Cu#28 and Cu—Zn#12 comprise inexpensive active compounds that may be used as fungicides. Nevertheless, it was of interest to identify a second anti-fungal product that could enhance further the anti-fungal activity of Cu#28 and/or Cu—Zn#12. One attractive candidate was potassium sorbate (KS), which is inexpensive and safe, being derived from sorbic acid, a natural product originally isolated from Rowan tree berries. It is widely used as a preservative (E number 202) in food and cosmetics and is classed as Generally-Regarded As Safe (GRAS). KS is highly soluble in water (58.2% at 20° C.) and is typically used at concentrations up to 0.1% (1000 milligrams/liter) in food and cosmetic products.

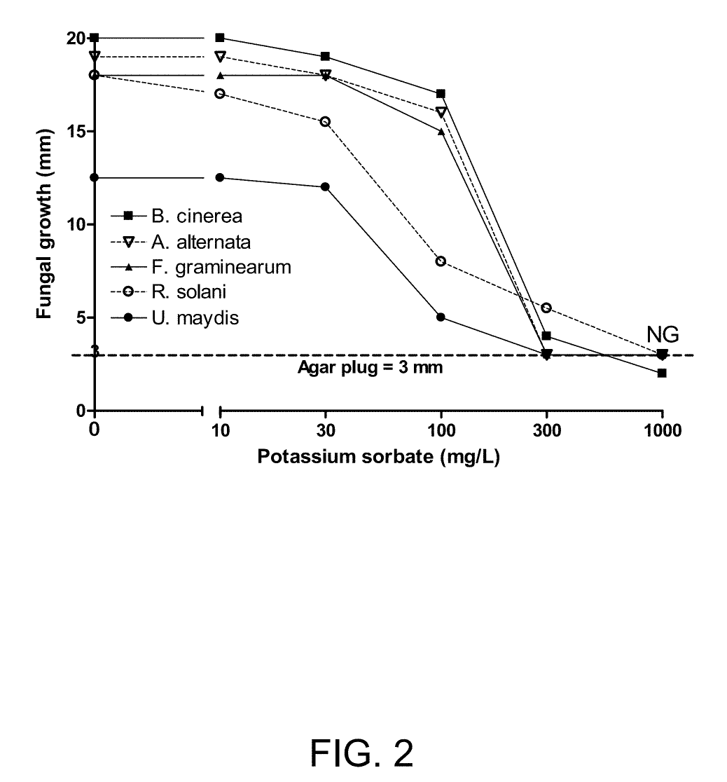

The effect of KS on the growth of all eight pathogenic fungi (see TABLE 2) was assessed. The dose-response curves for five fungal strains are shown in FIG. 2 and the IC₅₀ values for KS on all eight fungal strains are shown in TABLE 7. FIG. 2 is a graph depicting the effect of potassium sorbate on the growth of five plant pathogenic fungi. At 1000 milligrams/liter of KS there was no growth (NG) of any of the five fungal strains; B. cinerea was grown from spores and the NG diameter was 2 millimeters. IC₅₀ values for KS on all eight plant pathogenic fungi tested are shown in TABLE 7.

### Results.

FIG. 2 is a graph depicting the effect of potassium sorbate on the growth of five plant pathogenic fungi.

The results in FIG. 2 show that KS generally inhibited fungal growth in the range of 30 to 1000 micrograms/liter and this was confirmed for A. alternata, B. cinerea, F. graminearum, M. oryzae and M. graminicola, all of which had IC₅₀ values in this range (TABLE 7). The most sensitive fungal strain was U. maydis with an IC₅₀=77 micrograms/liter. The growth of all eight fungal strains was completely inhibited with 1000 milligrams/liter, and the growth of 4 strains was completely inhibited with 300 milligrams/liter of KS (TABLE 7).

TABLE 7
Potassium sorbate 50% inhibitory concentrations (IC₅₀) in
milligrams/liter for eight plant pathogenic fungi. Results
are from 1 to 3 experiments and shown as mean ± SD.

| | | Minimum KS |
|---|---|---|
| | | concentration |
| | Potassium sorbate | required for |
| Fungal strain | IC₅₀ (mg/L) | NG (mg/L) |
| A. alternata | 180, 200 = 190 ± 14 | 300 |
| A. niger | 82, 100 = 91 ± 13 | 300 |
| B. cinerea | 200, 150 = 175 ± 35 | 1000 |
| F. graminearum | 150, 220 = 185 ± 50 | 1000 |
| M. oryzae | 190, 150, 91 = 140 ± 50 | 1000 |
| M. graminicola | 150 | 300 |
| R. solani | 73, 100, 100 = 91 ± 16 | 1000 |
| U. maydis | 74, 80 = 77 ± 4 | 300 |

NG = no fungal growth.

Having established that the growth of all eight of the plant pathogenic fungi tested was inhibited by the highest concentrations of KS allowed in food (1000 milligrams/liter), experiments were set up using dose ranges of KS (typically from 10 to 300 milligrams/liter) with and without a concentration of Cu#28 or Cu—Zn#12 around their IC₅₀ value for the fungus being tested.

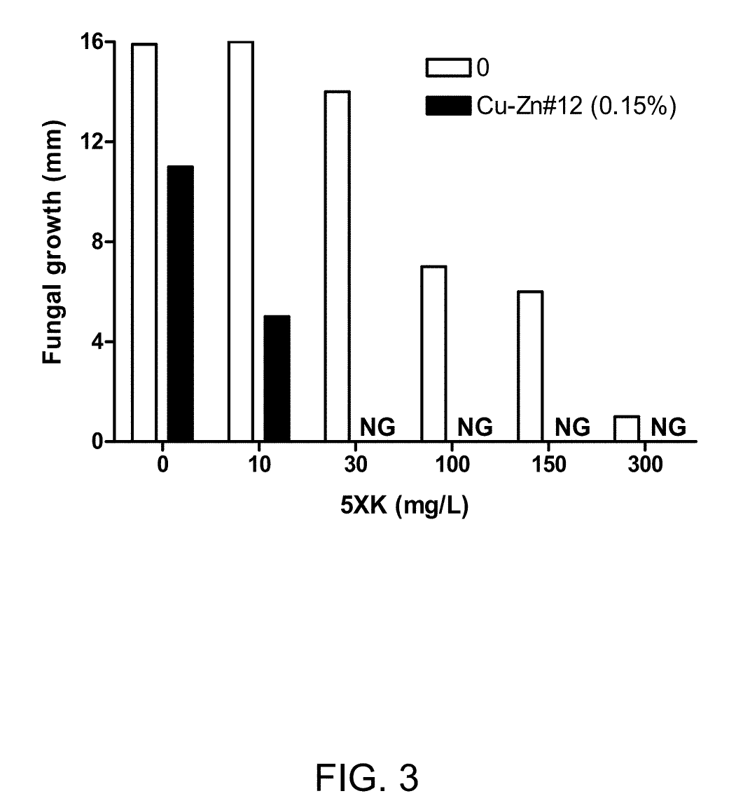

FIG. 3 is a graph depicting the effect of potassium sorbate on the growth of Magnaporthe oryzae in the presence and absence of composition Cu—Zn#12 (0.15% of stock solution). The diameter of fungal growth (in millimeters) is shown with the diameter of the agar plug (3 mm) subtracted from all data points. NG=no growth.

FIG. 3 shows the effect of combining Cu—Zn#12 (0.15% of stock solution) with various concentrations of KS on the growth of M. oryzae. In the absence of KS, Cu—Zn#12 inhibited fungal growth by 32%. When added with 10 milligrams/liter of KS, which has no effect on fungal growth alone, Cu—Zn#12 inhibited fungal growth by 68%. When combined with 30 milligrams/liter or higher concentrations of KS, 0.15% of Cu—Zn#12 completely inhibited fungal growth. As shown in TABLE 7, M. oryzae required 1000 milligrams/liter of KS for complete inhibition of fungal growth, yet in the presence of 0.15% Cu—Zn#12, KS at a concentration of only 30 milligrams/liter (33-times lower) completely inhibited the growth of M. oryzae. Looking at the results from the point of view of Cu—Zn#12, a concentration of 1% of Cu—Zn#12 alone is required to completely inhibit the growth of M. oryzae, so in the presence of 30 milligrams/liter of KS a 6.6-times lower concentration of Cu—Zn#12 can be used to effect complete inhibition of fungal growth.

This surprisingly effective synergistic inhibitory effect of KS and Cu—Zn#12 on the growth of M. oryzae (FIG. 3) was observed in similar experiments with all 8 of the fungal strains tested as shown in TABLE 8. The synergy of KS with copper sulfate was also strong in 6/7 strains tested. The synergy of KS with Zn#4 and phosphorous acid was observed with 4/7 strains tested, whilst the synergy of KS with zinc sulfate and potassium phosphite was only strong on 2 of the 7 strains tested (TABLE 8).

TABLE 8
A summary of experiments examining the synergy of potassium
sorbate with various compositions and compounds.
See legend for details.

| | *Potassium sorbate synergy with: | | | | | | |
|---|---|---|---|---|---|---|---|
| Fungal strain | C28 | CZ12 | CS | Z4 | ZS | KP | PA |
| A. alternata | NG | NG | NG | NG | NG | NG | NG |
| A. niger | NG | NG | NG | + | + | + | + |
| B. cinerea | NG | NG | ++ | NG | + | + | + |
| F. graminearum | NG | NG | NG | ++ | + | ++ | NG |
| M. oryzae | NG | NG | NG | NG | NG | NG | NG |
| M. graminicola | − | NG | − | | − | − | − |
| R. solani | NG | NG | NG | ++ | + | ++ | NG |
| U. maydis | NG | NG | NG | NG | ++ | ++ | ++ |

*Potassium sorbate and compositions/compounds were both used both at their IC₅₀ concentrations.
Maximal synergy (no growth) = NG;
moderate synergy = ++;
weak/no synergy = +;
− = Not tested.
C28 = Cu#28;
CZ12 = Cu—Zn#12;
CS = copper sulfate;
Z4 = Zn#4;
ZS = zinc sulfate;
KP = potassium phosphite;
PA = phosphorous acid.

The checkerboard experiment shown in TABLE 9 further illustrates the synergistic effect between KS and Cu—Zn#12 on M. oryzae. Although the effect of KS alone on fungal growth was modest in this experiment, it can be seen that all 3 concentrations of Cu—Zn#12 that also had little or no effect on fungal growth alone showed significant synergy with increasing concentrations of KS to the point where all 3 concentrations of Cu—Zn#12 with 300 mg/L of KS completely inhibited the growth of M. oryzae.

TABLE 9
The effect of increasing concentrations of both potassium sorbate
and Cu—Zn#12 on the growth of Magnaporthe oryzae on PDA.
The diameter of fungal growth (millimeters) is shown with the diameter
of the agar plug (2 mm) subtracted from all data points.

Average diameter of fungal growth (mm)
Cu—Zn#12 (% of stock solution)

| KS (mg/L) | 0 | 0.05 | 0.1 | 0.15 |
|---|---|---|---|---|
| 0 | 18 | 18 | 17 | 15 |
| 10 | 17 | 17 | 16 | 13 |
| 30 | 17 | 16 | 15 | 12 |
| 100 | 15 | 12 | 8 | NG |
| 150 | 14 | 11 | NG | NG |
| 300 | 9 | NG | NG | NG |

NG = no growth.

Taken together, these results show that whilst the synergy of KS with phosphorous acid and Zn#4 was modest on most strains, when copper is present (Cu#28, Cu—Zn#12 and copper sulfate) then a very strong synergy with KS was seen on all but one strain (B. cinerea) with copper sulfate (TABLE 8). Therefore, optimal KS synergy requires the presence of copper or copper and zinc combined with phosphorous acid. Since Cu—Zn#12 contains 50% less copper than Cu#28 (or copper sulfate), but shows equally strong synergy with KS, and since zinc has been shown to reduce phytotoxic effects of copper, the Cu—Zn# compositions are likely to be the preferred antifungal compositions for use in the field either alone, or in combination with KS, in which case it is likely that the concentration of the Cu—Zn# composition needed for effective antifungal activity would be even lower.

It is important to consider that the present studies only assessed the direct antifungal effects of the compositions, whereas on plants it could reasonably be expected that an additional antifungal/antibacterial effect would be seen since the phosphorous acid in the compositions enhances plant defences against microbial attack. Thus, whilst the concentrations of elemental copper and zinc in compositions to be used on plants are likely to be considerably lower than those present in Cu—Zn#12 (especially if used in combination with KS), the concentration of phosphorous acid can be held constant or increased in Cu—Zn# compositions in order to optimally enhance plant defences.

The Cu—Zn# compositions may also be preferable agrochemical fungicides to the Cu# compositions since they are more stable when stored (at 22° C.). Some Cu# compositions have a tendency to form crystal precipitates over time and this was seen with the Cu#28 composition used in the current studies (a fresh composition was made every 1 to 2 weeks), whereas Cu—Zn#12 showed no signs of precipitation after >4 months storage (at 22° C.).

KS requires a pH <6.5 in order to exert anti-fungal activity, so the pH of solutions containing Cu#28 or Cu—Zn#12 with or without KS at effective anti-fungal concentrations were measured. Tap water was used for the dilutions since this would be used in the field (rather than distilled water).

TABLE 10
Assessment of the pH of compositions diluted in
tap water with or without potassium sorbate.

| | |
|---|---|
| pH of 1% solution | pH of 0.3% solution |
| in tap water* | in tap water |

| Composition | +0 | +0.1% KS | +0 | +0.03% KS |
|---|---|---|---|---|
| Cu#28 | 4.02 | 4.76 | 4.78 | 5.51 |
| Cu—Zn#12 | 4.69 | 5.00 | 5.03 | 5.77 |

*The pH of tap water alone was 7.22.

TABLE 10 shows that Cu#28 and Cu—Zn#12 diluted to 0.3% or 1% of stock solution in tap water have pH values in the range 4.0 to 5.0. When KS was added at 0.03% or 0.1% to the Cu# or Cu—Zn# solutions the pH increased to a range of around 4.7 to 5.8.

These results indicate that both the Cu# and Cu—Zn# compositions diluted in tap water have pH's appropriate for optimal activity of KS (pH<6.5). Cu# and Cu—Zn# compositions can easily be formulated to achieve pH in the range 5 to 6 (the pH of rain water) with or without KS in tap water, so that they are suitable for use in agriculture at pH's that are environmentally and plant friendly.

Solutions of Cu#28, Cu—Zn#12 and Zn#4 >10% of stock solution concentration form suspensions or precipitates when combined with ≥1% weight/volume solutions of KS. However, diluted solutions of the Cu#, Cu—Zn# and Zn# compositions in water at concentrations that inhibit fungal growth (≤1% of stock solutions), can be combined with solutions of KS (≤0.1% weight/volume) without precipitation and with surprisingly strong synergistic effects on the inhibition of fungal growth as described above.

Therefore, it is envisaged that for practical use in the field, the Cu#, Cu—Zn# or Zn# stock solution would be diluted in water with constant mixing before a stock solution of KS is carefully added. A suitable adjuvant or “spreader/sticker” (wetting and adhesion) product could then be added to the synergistic anti-fungal combination (with constant mixing) to complete and optimize the formulation for plant protection by, for example, spraying onto crops, vines, trees etc. Examples of such products include, but are not limited to, Carbowet™, an ethoxylated nonionic surfactant manufactured and sold by Air Products and Chemicals, Inc. of Allentown, Pa.; Surfynol™, a nonionic wetting agent and molecular defoamer, also by Air Products and Chemicals, Inc.; and Chem-Stik, a “Nonionic spreader sticker maximizes leaf surface coverage of spray solutions, while providing washoff protection from untimely rainfall,” as described at http://www.precisionlab.com/turf-and-ornamentals/products/spray-tank-adjuvants/chem-stik-nonionic-spreader-sticker by the product manufacturer, Precision Laboratories LLC of Waukegan, Ill., USA.

### EXAMPLE 3

### The Effect of Cu—Zn#12 on Magnaporthe oryzae Spore Germination and in Planta Studies

M. oryzae germination assay: Spores were harvested from confluent cultures of M. oryzae grown on Complete Medium agar (Talbot N. J. et al., The Plant Cell 5:1575-1590, 1993). Samples of the spore suspension were centrifuged for 10 minutes at 18,000 g and the supernatant replaced with an equal volume of Cu—Zn#12 at various concentrations diluted in DW. Droplets of the spore suspension were placed onto hydrophobic glass slides and incubated in a humidity chamber at 18° C. for 24 hours. Cover slips were placed on the droplets and the number of germinated spores was enumerated by light microscopy using a haemocytometer.

In planta studies: Rice plants (Oryzae sativa, cv C039, susceptible to rice blast infection) were grown on John Innes no. 2 compost at 20° C. (day) and 18° C. (night) with 16 hours per day of supplementary lighting. 14 day old rice plants were sprayed with 0.1% (w/v) gelatine in sterile distilled water (control) or Cu—Zn#12 dissolved in the control medium using a glass reagent sprayer with a rubber bulb, to produce a fine mist.

For phytotoxicity studies, 3-5 leaves per spray treatment were photographed 7 days after spraying and the photographs were analyzed using color thresholding in ImageJ (a public domain image processing program developed at the National Institutes of Health, United States Department of Health and Human Services), to show the percent of leaf surface showing chlorosis (yellow color) or necrosis (brown color) as described by Schneider C. A. et al., Nature Methods 9:671-675, 2012.

To visualise defense signaling, 3′,3′-diaminobenzidine (DAB) staining for hydrogen peroxide was used. Plants were sprayed as described above and 2 days later the plants were infected by spraying with spores of M. oryzae (1×10⁷/millilitre) in 0.1% (w/v) gelatine in sterile distilled water. 7 days post-infection, groups of 3 to 5 leaves were transferred to a 0.1% (weight/volume) DAB solution in DW. After 18 hours in the staining solution, the leaves were transferred to methanol until all chlorophyll was removed. The bleached leaves were then placed on laminated white paper and scanned to provide high resolution images which were then analyzed using ImageJ to measure the percent surface area of each leaf stained red-brown by DAB.

For M. oryzae infection studies, rice plants were transferred to growth chambers with the same temperature and lighting conditions. The plants were sprayed with M. oryzae spores as described above and photographed 5 days later.

### Results.

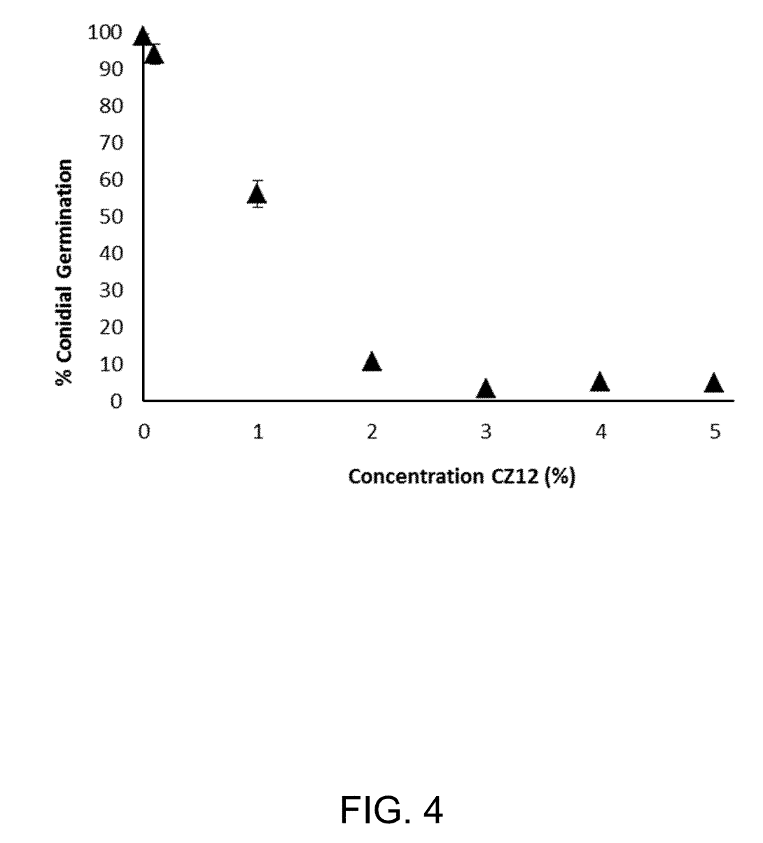

FIG. 4 is a graph depicting the inhibition of Magnaporthe oryzae spore germination by Cu—Zn#12. Spores (5×10⁴ spores/milliliter) were suspended in different concentrations of Cu—Zn#12 and germination was assessed after 24 hours incubation.

FIG. 4 shows that Cu—Zn#12 inhibited the germination of M. oryzae spores in a concentration-dependent manner. The concentration of Cu—Zn#12 required to inhibit spore germination by 50% was calculated to be 1.5% (of Cu—Zn#12 stock solution). These results show that Cu—Zn#12 not only inhibits fungal growth of M. oryzae on Petri dishes, but also inhibits germination of M. oryzae spores. This is potentially important for use in the field where preventative activity (inhibition of spore germination) is a desirable property of a fungicide.

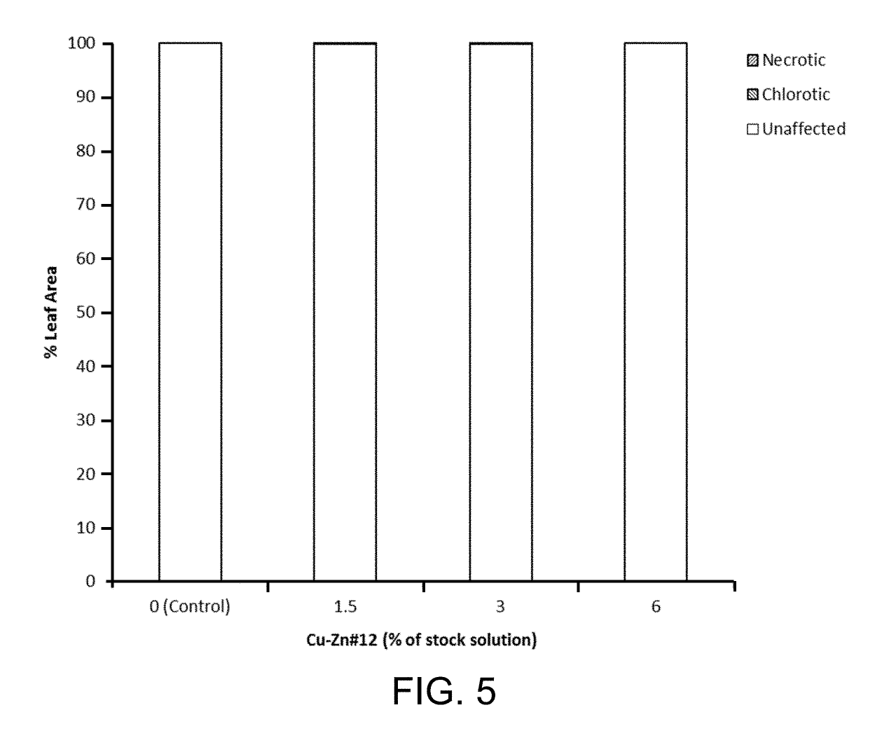

FIG. 5 is a graph depicting the lack of phytotoxicity of Cu—Zn#12 to rice plants. Phytotoxicity was assessed by measuring rice plant leaf area showing chlorosis or necrosis 7 days after treatment with various concentrations of Cu—Zn#12. FIG. 5 shows that rice plants sprayed with concentrations of Cu—Zn#12 as high as 6% (of stock solution) showed minimal levels of chlorosis or necrosis (less than 1% of total leaf area). In addition, no significant phytotoxicity of Cu—Zn#12 was observed when the levels of chlorophyll and anthocyanin in treated rice leaves were measured (data not shown). These results show that even at concentrations as high as 6% of stock solution, Cu—Zn#12 is not phytotoxic to rice plants.

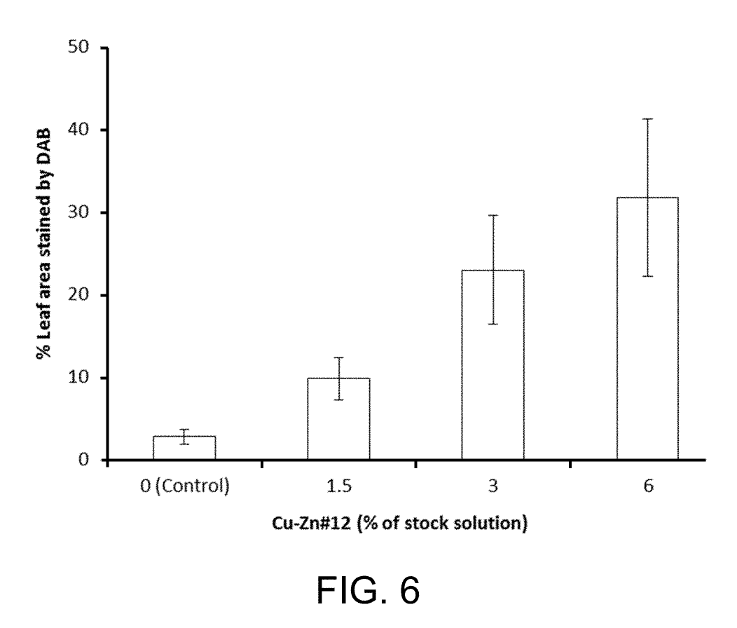

FIG. 6 is a graph depicting defense signaling by Cu—Zn#12-treated rice plants in response to infection with Magnaporthe oryzae. Rice plants were treated with various concentrations of Cu—Zn#12 and, 48 hours subsequently, infected with Magnaporthe oryzae (10⁷ spores/milliliter). Seven days after infection, 3-5 leaves per treatment were sampled and stained with DAB to reveal the extent of defence-related hydrogen peroxide levels.

FIG. 6 shows the defence priming effect of Cu—Zn#12 on rice plants subsequently infected with M. oryzae. The rice plants were treated with water (control) or Cu—Zn#12 at different concentrations and then 2 days later the plants were infected by spraying with spores of M. oryzae. Seven days post-infection, the defence priming response was evaluated by measuring hydrogen peroxide production in the leaves by staining with DAB (3′,3′-diaminobenzidine). The results show a concentration-dependent increase in DAB staining in the leaves of plants treated with Cu—Zn#12 before infection with M. oryzae, and clearly demonstrate that Cu—Zn#12 can prime rice plants in defence against infection by M. oryzae.

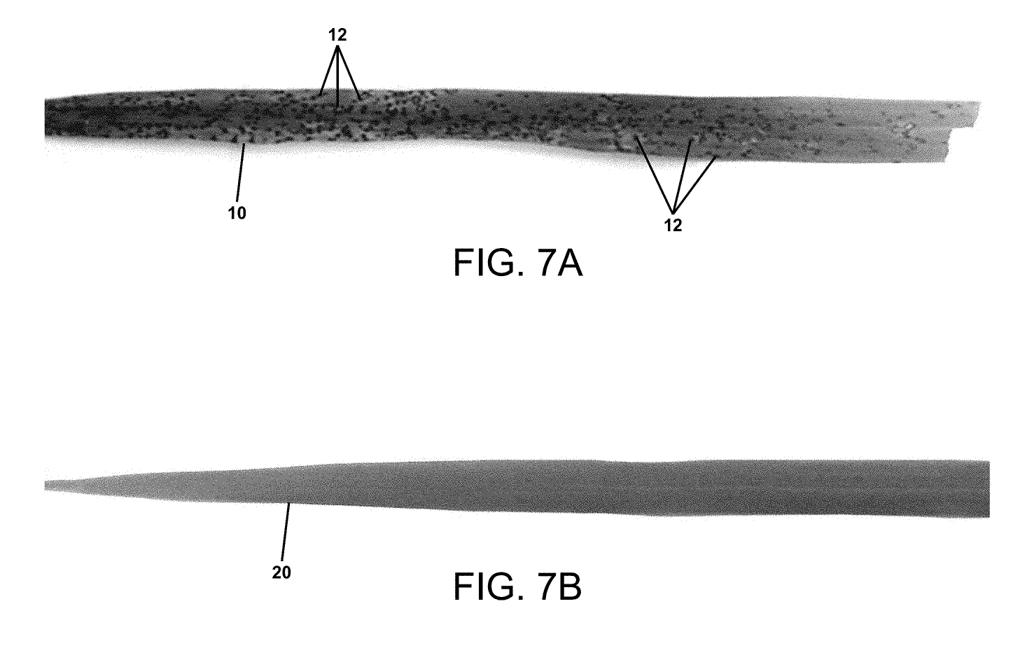

FIGS. 7A and 7B are photographs depicting the effect of Magnaporthe oryzae infection on rice leaves treated with Cu—Zn#12. FIG. 7A depicts a rice plant leaf that was sprayed with 0.1% (w/v) gelatine in sterile distilled water as control. FIG. 7B depicts a rice plant leaf that was sprayed with Cu—Zn#12 (3% of stock solution. 48 hours subsequently, each of the leaves depicted in FIGS. 7A and 7B were infected with Magnaporthe oryzae (10⁷ spores/ml). Lesion development on the leaves was photographed 5 days after infection.

Comparing the photograph of FIG. 7A with that of FIG. 7B, it is clear that the control leaf 10 of FIG. 7A that was not treated with the antimicrobial composition showed extensive fungal disease lesions 12, while the leaf 20 of FIG. 7B that was pre-treated with 3% Cu—Zn#12 had far fewer lesions. (A quantitative analysis indicated around 65% fewer lesions.) Similar results were seen with leaves from rice plants pre-treated with 1.5% Cu—Zn#12 (data not shown).

Taken together, the results show that (i) Cu—Zn#12 stimulates the defense priming response of rice plants but is not phytotoxic to rice plants, and (ii) Cu—Zn#12 is an effective inhibitor of M. oryzae spore germination and reduces fungal disease lesions on rice plants infected with M. oryzae spores. These results demonstrate the potential utility of copper-zinc ammonium complexes solubilized with phosphorous acid as agricultural fungicides.

### EXAMPLE 4

### Fungal Growth Inhibition Assays with Trichophyton rubrum

A clinical isolate of T. rubrum (strain 7107996; Phylum: Acomycota) was kindly provided by Dr. Richard Barton, Leeds University, UK. The growth assays with T. rubrum were as described in EXAMPLE 1, except this strain was cultured at 33° C. on PDA for 6 or 7 days when growth was assessed. T. rubrum cultures were maintained on Sabouraud dextrose agar at 33° C.

### Results.

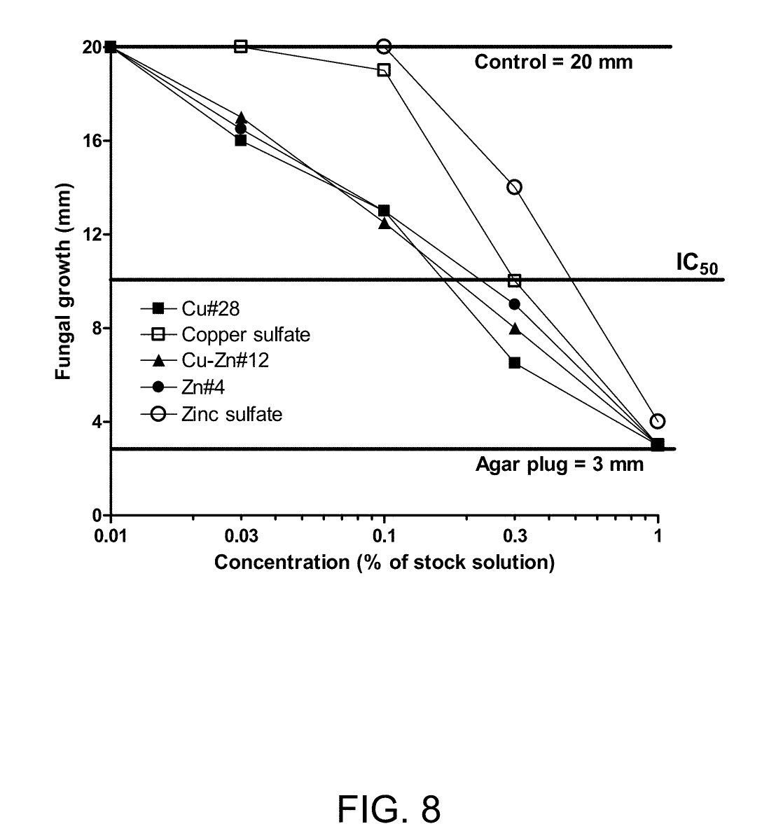

FIG. 8 is a graph depicting the effects of selected compositions and compounds on the growth of Trichophyton rubrum. The culture period was 7 days. Growth in the control cultures was 20±0 millimeters (mean±SD for 2 experiments). The 50% inhibitory concentration (IC₅₀) for compositions was that at which hyphal growth was 10.0 millimeters.

The results in FIG. 8 and TABLE 11 show that copper sulfate and zinc sulfate were considerably less active inhibitors of the growth of T. rubrum than the comparable Cu#28 and Zn#4 compositions, as was seen with the plant pathogenic fungi (TABLE 3). Cu—Zn#12 had comparable activity to Cu#28 and Zn#4. However, unlike the plant pathogenic fungi, phosphorous acid was a strong inhibitor of the T. rubrum growth. T. rubrum growth was also very sensitive to potassium sorbate (KS) with an IC₅₀ of 17 milligrams/liter (TABLE 11), whereas the IC50 for KS on plant pathogenic fungi ranged from 77 to 190 milligrams/liter.

TABLE 11
Concentrations of compositions and compounds that inhibited
hyphal growth of Trichophyton rubrum by 50% (IC₅₀).

| | T. rubrum IC₅₀ values: |
|---|---|
| Composition | % of stock solution/Concentration in mg/L |
| Cu#28 | 0.052/21 |
| Cu—Zn#12** | 0.065/26 |
| Copper sulfate | 0.20/80 |
| Zn#4 | 0.078/31 |
| Zinc sulfate | 0.25/100 |
| H₃PO₃ | 0.05/20 |
| Potassium sorbate | 0.017/17 |

The concentration of each composition in mg/L is also shown;
**except in the case of Cu—Zn#12 where the concentration in mg/L is 50% each of elemental copper and zinc.

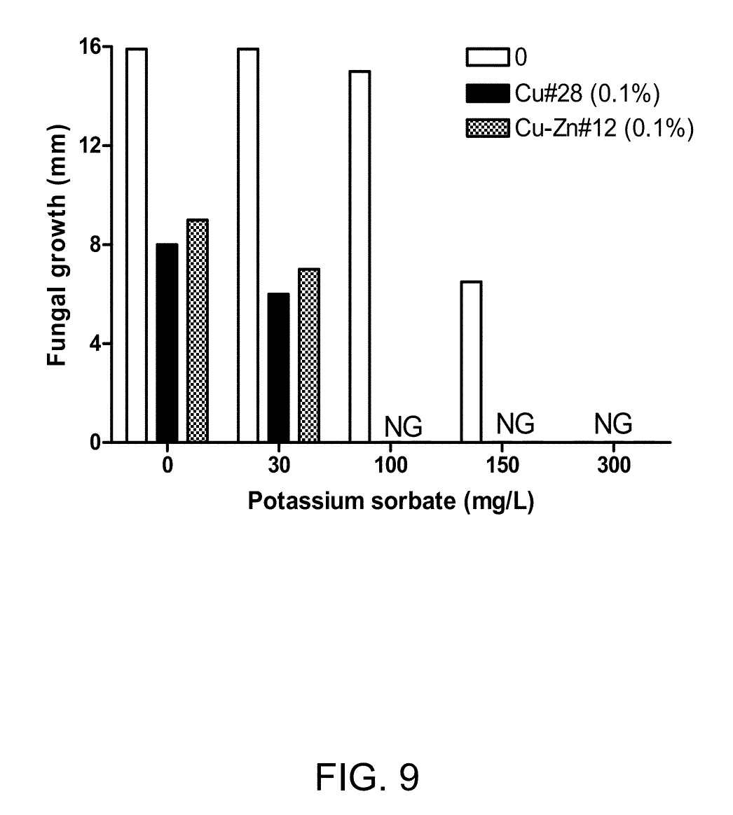

FIG. 9 is a graph depicting the effect of potassium sorbate on the growth of Trichophyton rubrum in the presence and absence of compositions Cu#28 and Cu—Zn#12 (0.1% of stock solution). The diameter of fungal growth (in millimeters) is shown with the diameter of the agar plug (3 mm) subtracted from all data points. NG=no growth.

FIG. 9 shows the effect of combining Cu#28 or Cu—Zn#12 (0.1% of stock solutions) with various concentrations of KS on the growth of T. rubrum. In the absence of KS, Cu#28 and Cu—Zn#12 both inhibited fungal growth by around 50%. When added together with 100 milligrams/liter of KS, which inhibited fungal growth by 6% on its own, both Cu#28 and Cu—Zn#12 completely inhibited fungal growth. T. rubrum required 300 milligrams/liter of KS (FIG. 9) and 1% of Cu#28 or Cu—Zn#12 (FIG. 8) for complete inhibition of fungal growth, yet in the presence of 0.1% Cu#28 (40 milligrams/liter of elemental copper) or Cu—Zn#12, KS at a concentration of 100 milligrams/liter completely inhibited the growth of T. rubrum, showing clear synergy between the Cu# and Cu—Zn# compositions and KS, as was seen with the plant pathogenic fungi (TABLE 8).

Taken together, these results show that the growth of T. rubrum is more sensitive to the phosphorous acid-solubilized Cu and Cu—Zn compositions compared to copper sulfate and zinc sulfate alone, as was seen with the plant pathogenic fungi. However, T. rubrum growth was considerably more sensitive to phosphorous acid and KS than the plant pathogenic fungi. T. rubrum was also very sensitive to the combination of Cu#28 or Cu—Zn#12 with KS, suggesting this may be a useful treatment/cure for athlete's foot and other diseases caused by T. rubrum.

### EXAMPLE 5

### Bacterial Microplate Cultures with 4 Strains of Plant Pathogenic Bacteria

TABLE 12
Bacterial strains used in these studies.

| Bacterial strain | Disease caused by bacteria |
|---|---|
| Pseudomonas syringae | More than 50 pathovars that |
| (pv. tomato DC3000) | cause bacterial speck on |
| | leaves and fruit, and |
| | cankers on trees. |
| Ralstonia solanacearum | Causes lethal wilting in |
| (strain PSS4 from tomato) | tomatoes, potatoes, bananas |
| | and numerous other plants. |
| Xanthomonas oryzae | Causes rice blight disease. |
| (strain Gx0372) | |
| Xanthomonas campestris | Causes bacterial spots and |
| (strain Race 5 from brassica) | blights of leaves, stems, |
| | and fruits on a wide variety |
| | of plant species. |

The four Gram negative bacterial strains shown in TABLE 12 were cultured in King's B medium at 28° C. Stock solutions of the compounds/compositions to be tested were diluted so that double dilutions in the microplate assays commenced at a 1% vol/vol concentration (e.g. 400 milligrams/liter elemental copper in the case of Cu#28). Double dilutions of the compositions to be tested (in 0.1 milliliters) were prepared in a 1:1 vol/vol mixture of King's B medium and RPMI-1640 (KR medium) in a 96-well tissue culture plate. Overnight bacterial cultures were diluted 1:40 with fresh KR medium and added to the compositions (0.09 milliliters) along with resazurin A (0.01 milliliters of a sterile 0.0675% solution in distilled water) as an indicator of bacterial growth. The plates were then incubated at 28° C. for 24 hours. The minimum inhibitory concentration (MIC) of the compositions was defined as the lowest concentration at which the resazurin A indicator remained blue.

### Results.

The results in TABLE 13 show that the growth of all 4 bacterial strains was more sensitive to the copper-containing compositions (MIC=50-100 milligrams/liter) than the zinc-containing compositions (MICs=400 or >400 milligrams/liter). The growth of the 2 Xanthomonas strains was less sensitive to phosphorous acid than the other 2 strains. KS had no effect on the growth of any strain at ≥10,000 milligrams/liter. Addition of KS (0.1% wt/vol=1,000 milligrams/litre) to the 1 to 0.016% dilution range of Cu#28 or Cu—Zn#12 had no effect on the MIC observed with P. syringae or X. campestris (data not shown).

These results suggest that the use in the field of the Cu# or Cu—Zn# compositions at concentrations of 100 micrograms/milliliter or higher (with or without ≤0.1% wt/vol KS) would be likely to have a direct inhibitory effect on the growth of plant pathogenic bacteria in addition to fungi. In addition, the ability of the phosphorous acid-containing Cu# and Cu—Zn# compositions to activate plant defences might be expected to further enhance this direct effect on bacterial growth.

TABLE 13
The effect of compositions and compounds on the growth of
4 plant pathogenic bacterial strains. The bacteria were
cultured for 24 hours at 28° C. with doubling dilutions
of the compositions and compounds with a highest concentration
of 400 milligrams/liter (1% of stock solutions).

| | *MIC (mg/L) | | | |
|---|---|---|---|---|
| | P. | R. | X. | X. |
| Composition | syringae | solanacearum | oryzae | campestris |
| Cu#28 | 100 | 50 | 50 | 50 |
| Copper sulfate | 100 | 50 | 50 | 50 |
| Cu—Zn#12** | 100 | 100 | 50 | 100 |
| Zn#4 | 400 | >400 | 400 | >400 |
| Zinc sulfate | 400 | >400 | 400 | >400 |
| Phosphorous | 200 | 100 | 400 | >400 |
| acid | | | | |
| Potassium | >10,000 | >10,000 | >10,000 | >10,000 |
| sorbate | | | | |

*MIC = Minimum Inhibitory Concentration
**An MIC of 100 mg/L represents 50 mg/L each of elemental copper and zinc.

To use the composition of the present invention to control phytopathogenic fungi in crops, the composition may be applied to a seed, a plant, a fruit of the plant, or to soil on which the plant grows or soil from which the seed, the plant, or the fruit of the plant grows. The composition may be applied as a foliar treatment. The composition may also be applied to the seed. Alternatively or additionally, the composition may be applied to the soil in which the plant is to be grown. In some embodiments, the composition may be applied to the seed, plant, fruit or soil prior to attack by phytopathogenic fungi.

In some embodiments of methods of the present invention, the plant to be treated may be a transgenic plant. In some embodiments that include treatment of seeds, the seed may be a seed of a transgenic plant.

The phytopathogenic fungi that are inhibitable by compositions of the present invention may include, but are not limited to, Plasmodiophoromycetes, Oomycetes, Chytridiomycetes, Zygomycetes, Ascomycetes, Basidiomycetes and Deuteromycetes.

Plants that are treatable by compositions of the present invention may include, but are not limited to, cereals, maize, cotton, soy bean, rice, potatoes, sunflowers, beans, coffee, beets, strawberries, vines, cucurbits, peanuts, rapeseed, poppies, olives, coconuts, cacao, sugar cane, tobacco, vegetables, lawn, ornamental plants, bushes and trees.

Without wishing to be bound to any particular theory, the Applicants believe that the efficacy of the anti-microbial compositions of the present disclosure in the treatment of a plant may result from the compositions having the effect of preventing time zero infection of the plant by the microbe, preventing cellular replication by the microbe, reducing the rate of cellular replication by the microbe, or killing living cells of the microbe.

It is therefore apparent that there has been provided, in accordance with the present disclosure, anti-microbial compositions having heretofore unknown synergistic anti-microbial efficacy, methods for preparation of such compositions, and methods of inhibiting microbial infections using such compositions. Having thus described the basic concept of the invention, it will be apparent to those skilled in the art that the foregoing detailed disclosure is intended to be presented by way of example only, and is not limiting. Various alterations, improvements, and modifications will occur to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be expressly stated in the claims.

1-12. (canceled)

13. A method of making an antimicrobial composition, the method comprising:
a) dissolving a metal salt in water to form a metal salt aqueous solution, the metal salt selected from the group consisting of copper salt, zinc salt, and mixtures thereof;
b) adding a source of ammonium to the metal salt aqueous solution to form an insoluble metal-ammonium complex; and
c) adding an amount of an acid effective to solubilize the insoluble metal-ammonium complex, thereby forming an aqueous solution of solubilized metal-ammonium complex.

14. The method of claim 13, wherein the acid is selected from the group consisting of phosphoric acid, phosphorous acid, and citric acid.

15. The method of claim 13, wherein the source of ammonium is selected from the group consisting of ammonium carbonate, ammonium hydrogen carbonate, and ammonium hydroxide.

16. The method of claim 13, further comprising adding solubilized aqueous sorbate ion to the aqueous solution of solubilized metal-ammonium complex.

17. The method of claim 13, further comprising diluting the aqueous solution of solubilized metal-ammonium complex with water by a factor of between 100 and 1000.

18. The method of claim 17, further comprising adding at least one adjuvant selected from a carrier, a surfactant, an extender, or a spreader/sticker to the aqueous solution of solubilized metal-ammonium complex.

19. The method of claim 13, wherein the adding ammonium to the metal salt aqueous solution is performed by adding ammonium hydroxide to the metal salt aqueous solution.

20. The method of claim 19, wherein the acid is selected from the group consisting of phosphoric acid, phosphorous acid, and citric acid.

21. The method of claim 13, wherein the concentration of elemental metal in the composition is between 1 and 10 grams/deciliter.

22. The method of claim 13, wherein the metal-ammonium complex is copper-zinc-ammonium complex.

23. The method of claim 22, wherein the ratio of concentration of elemental copper to concentration of elemental zinc is about 1:1.

24-28. (canceled)
